(19) United States
(12) Patent Application Publication
(10) Pub. No.: US 2008/0117322 A1
(43) Pub. Date: May 22, 2008

(54) IMAGE PICKUP DEVICE AND IMAGING APPARATUS USING THE SAME

(75) Inventor: Nobuyuki TOKUOKA, Kyoto (JP)

Correspondence Address: SUGHRUE MION, PLLC, 2100 PENNSYLVANIA AVENUE, N.W., SUITE 800, WASHINGTON, DC, 20037, US

(73) Assignee: SHIMADZU CORPORATION, Kyoto-shi (JP)

(21) Appl. No.: 11/941,124

(22) Filed: Nov. 16, 2007

(30) Foreign Application Priority Data
Nov. 17, 2006 (JP) 2006-311581

(51) Int. Cl. H04N 5/335

(52) U.S. Cl. 348/311; 348/E05.091

(57) ABSTRACT

Disclosed are an image pickup device and an imaging apparatus using the image pickup device. The image pickup device a photodiode for converting incident light to electric charge and generate a signal charge corresponding to an intensity of the incident light, a CCD cell for accumulatively storing respective signal charges generated from the photodiode, and transferring the signal charges to outside. In the image pickup device, a light-receptor board formed with the photodiode and a CCD-cell board formed with the CCD cell are arranged separately from each other and electrically connected to each other.

### BACKGROUND OF THE INVENTION

1. Field of the Invention

The present invention relates to an image pickup device for picking up an image of an object in such a manner as to convert incident light to electric charge and generate a signal charge corresponding to an intensity of the incident light. The present invention also relates to an imaging apparatus using the image pickup device.

2. Description of the Related Art

As one type of image pickup devices, there has been known a CCD (Charge Coupled Device)-type solid-state image pickup device. With a view to allowing for high-speed imaging, a recent CCD-type solid-state image pickup device (hereinafter referred to briefly as “CCD”) is provided with a photoelectric conversion section (e.g., a photodiode) operable to convert incident light to electric charge and generate a signal charge corresponding to an intensity of the incident light, and a plurality of charge accumulation sections (e.g., charge-accumulating CCD cells) provided on one side of the photoelectric conversion section to accumulatively store respective signal charges generated from the photoelectric conversion section (see, for example, JP 09-055889A). The photoelectric conversion section and the charge accumulation sections are mounted on a chip (semiconductor substrate). The CCD equipped with the plurality of charge accumulation sections makes it possible to achieve high-speed imaging.

In reality, each of the photoelectric conversion section typified by a photodiode and the charge accumulation section typified by a charge-accumulating CCD cell is restricted in number due to the arrangement where they are mounted on a chip (semiconductor substrate). For example, if the number of photodiodes is increased to provide enhanced resolution, the number of charge-accumulating CCD cells will be reduced to cause a reduction in the number of shots (i.e., frames). Conversely, if the number of charge-accumulating CCD cells is increased to provide an increased number of shots, the number of photodiodes will be reduced to cause a decrease in resolution.

In the image pickup device designed for high-speed imaging, the charge-accumulating CCD cells occupy a larger part of an area thereof as compared with an image pickup device designed for normal-speed imaging. Thus, an aperture ratio, i.e., a ratio of an area of a light-receiving portion of the photodiode to a sensor size of the image pickup device, is reduced to cause a decrease in sensitivity. Moreover, the charge-accumulating CCD cells are formed on the common semiconductor substrate together with the photodiode. This arrangement is likely to cause light leak from the photodiode into the charge-accumulating CCD cells, resulting in deteriorated image quality.

### SUMMARY OF THE INVENTION

In view of the above circumstances, it is an object of the present invention to provide an image pickup device capable of achieving enhanced flexibility in design for photoelectric conversion means and charge accumulation means, and preventing leak of light and/or a signal charge from the photoelectric conversion means into the charge accumulation means so as to avoid deterioration in image quality. It is another object of the present invention to provide an imaging apparatus using the image pickup device.

In order to achieve the above objects, as set forth in the appended claim 1, the present invention provides an image pickup device which comprises photoelectric conversion means operable to convert incident light to electric charge and generate a signal charge corresponding to an intensity of the incident light, a plurality of charge accumulation means operable to accumulatively store respective signal charges generated from the photoelectric conversion means, and charge transfer means operable to read out each of the signal charges accumulated in the plurality of charge accumulation means and transfer the read-out signal charge to outside. In the image pickup device, the photoelectric conversion means is formed as a part of a first board, and the plurality of charge accumulation means and the charge transfer means are formed as a part of a second board. The first and second boards are arranged separately from each other and electrically connected to each other.

In the image pickup device of the present invention, the first board formed with the photoelectric conversion means, and the second board formed with the plurality of charge accumulation means and the charge transfer means, are arranged separately from each other and electrically connected to each other. The separate arrangement between the first and second boards allows restrictions on design for the photoelectric conversion means and the charge accumulation means to be reduced. This makes it possible to provide enhanced flexibility in design for the photoelectric conversion means and the charge accumulation means. In addition, the separate arrangement between the first and second boards allows the photoelectric conversion means and the charge accumulation means formed in the respective boards to be disposed in spaced-apart relation to each other. This makes it possible to prevent leak of light and/or a signal charge from the photoelectric conversion means into the charge accumulation means so as to avoid deterioration in image quality. As used in this specification, the term “high-speed imaging” means an imaging mode requiring a shooting speed which is 100,000 frames/sec or more.

The image pickup device includes photoelectric conversion means operable to convert incident light to electric charge and generate a signal charge corresponding to an intensity of the incident light, a plurality of charge accumulation means operable to accumulatively store respective signal charges generated from the photoelectric conversion means, and charge transfer means operable to read out each of the signal charges accumulated in the plurality of charge accumulation means and transfer the read-out signal charge to outside, wherein the photoelectric conversion means is formed as a part of a first board, and the plurality of charge accumulation means and the charge transfer means are formed as a part of a second board, and wherein the first and second boards are arranged separately from each other and electrically connected to each other.

In the imaging apparatus of the present invention, the first board formed with the photoelectric conversion means, and the second board formed with the plurality of charge accumulation means and the charge transfer means, are arranged separately from each other. This makes it possible to reduce restrictions on design for the photoelectric conversion means and the charge accumulation means so as to provide enhanced flexibility in design for the photoelectric conversion means and the charge accumulation means. In addition, the separate arrangement between the first and second boards allows the photoelectric conversion means and the charge accumulation means formed in the respective boards to be disposed in spaced-apart relation to each other. This makes it possible to prevent leak of light and/or a signal charge from the photoelectric conversion means into the charge accumulation means so as to avoid deterioration in image quality.

Preferably, in the image pickup device of the present invention, the photoelectric conversion means and a predetermined one of the plurality of charge accumulation means are associated in one-to-one corresponding relation with each other, and the plurality of charge accumulation means are connected in series in such a manner that the predetermined charge accumulation means associated in one-to-one corresponding relation with the photoelectric conversion means is set as an initial one of the series-connected charge accumulation means, and a last one of the series-connected charge accumulation means is connected to the charge transfer means. According to this feature, signal charges to be accumulatively stored can be adjusted depending on the number of charge accumulation means connected in series.

Preferably, in the image pickup device of the present invention, the plurality of charge accumulation means are connected in series, and operable to sequentially accumulate respective signal charges in the series-connected charge accumulation means in a sequentially shifting manner, and the charge transfer means is operable to transfer each of the sequentially accumulated and shifted signal charges to outside at a predetermined timing. According to this feature, signal charges to be accumulatively stored can be adjusted depending on the number of the charge accumulation means connected in series, while reliably shifting and transferring the signal charges.

Preferably, the image pickup device of the present invention includes collection means operable to collect respective signal charges generated from the photoelectric conversion means and deliver the collected signal charges to the charge transfer means, wherein the collection means is formed as a part of the second board having the plurality of charge accumulation means. According to this feature, the collection means is formed as a part of the second board having the plurality of charge accumulation means. This makes it possible to prevent leak of light and/or a signal charge from the photoelectric conversion means into the collection means. The prevention of the leak into the collection means also allows the leak into the charge transfer means to be avoided.

As above, in the image pickup device and the imaging apparatus of the present invention, the first board formed with the photoelectric conversion means, and the second board formed with the plurality of charge accumulation means and the charge transfer means, are arranged separately from each other. This makes it possible to reduce restrictions on design for the photoelectric conversion means and the charge accumulation means so as to provide enhanced flexibility in design for the photoelectric conversion means and the charge accumulation means. In addition, the separate arrangement between the first and second boards allows the photoelectric conversion means and the charge accumulation means formed in the respective boards to be disposed in spaced-apart relation to each other. This makes it possible to prevent leak of light and/or a signal charge from the photoelectric conversion means into the charge accumulation means so as to avoid deterioration in image quality.

These and other objects, features, and advantages of the present invention will become apparent upon reading the following detailed description along with the accompanying drawings.

### BRIEF DESCRIPTION OF THE DRAWINGS

FIG. 1 is a block diagram schematically showing an imaging apparatus using a CCD-type solid-state image pickup device (CCD), according to one embodiment of the present invention.

FIG. 2 is a block diagram showing the configuration of the CCD in the embodiment.

FIG. 3 is a sectional view showing the structure of the CCD in the embodiment.

FIG. 4 is a top plan view showing the configuration of the CCD in the embodiment.

### DESCRIPTION OF THE EXEMPLARY EMBODIMENTS

With reference to the drawings, the present invention will now be specifically described based on one embodiment thereof.

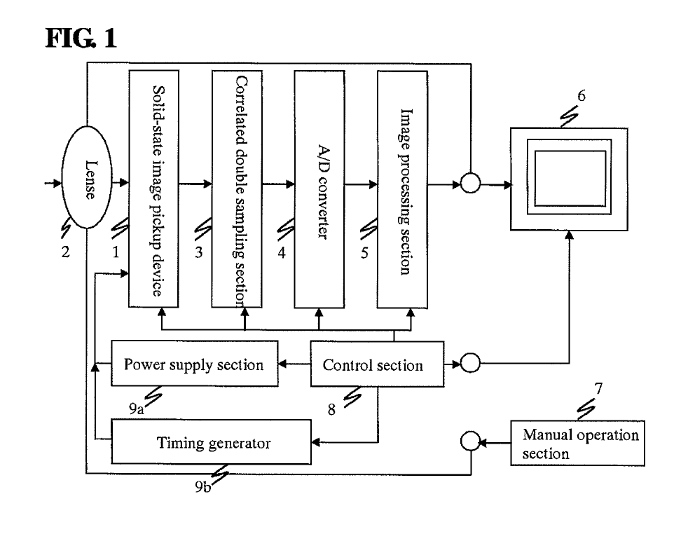

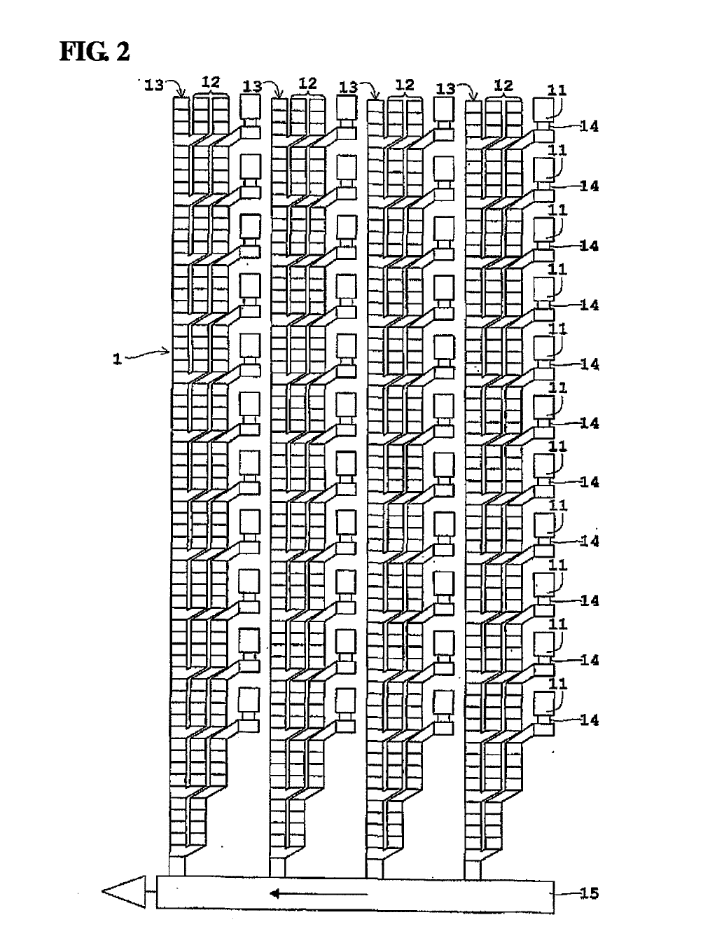

FIG. 1 is a block diagram schematically showing an imaging apparatus using a CCD-type solid-state image pickup device (CCD), according to the embodiment, and FIG. 2 is a block diagram showing the configuration of the CCD.

The imaging apparatus according to this embodiment is designed to pick up an optical image of an object, and convert the picked-up image to a signal charge and then to an electric signal so as to image the object. Specifically, as shown in FIG. 1, the imaging apparatus comprises a solid-state image pickup device (CCD) 1, a lens 2, a correlated double sampling (CDS) section 3, an analog-digital (A/D) converter 4, an image processing section 5, a monitor 6, a manual operation section 7, and a control section 8. The imaging apparatus further includes a power supply section 9a and a timing generator 9b. This imaging apparatus is used as a high-speed imaging apparatus having a shooting speed of 1.0×10⁶ frames/sec (1,000,000 frames/sec). The solid-state image pickup device (CCD) 1 serves as the image pickup device set forth in the present invention.

The lens 2 is operable to introduce an optical image of an object therethrough. The correlated double sampling (CDS) section 3 is operable to amplify a signal charge sampled from the CCD 1, in a low-noise manner, and convert the amplified signal charge to an electric signal. The A/D converter 4 is operable to convert the electric signal from the CDS section 3, to a digital signal. The image processing section 5 is operable to perform various processings based on the digital signal from the A/D converter 4, so as to create a two-dimensional image. The monitor 6 is operable to output the two-dimensional image created in the image processing section 5, on a screen thereof. The manual operation section 7 is operable to accept various manual operations necessary for executing an imaging control. The control section 8 is operable to generally control the entire apparatus according to shooting conditions set using the manual operation section 7, etc.

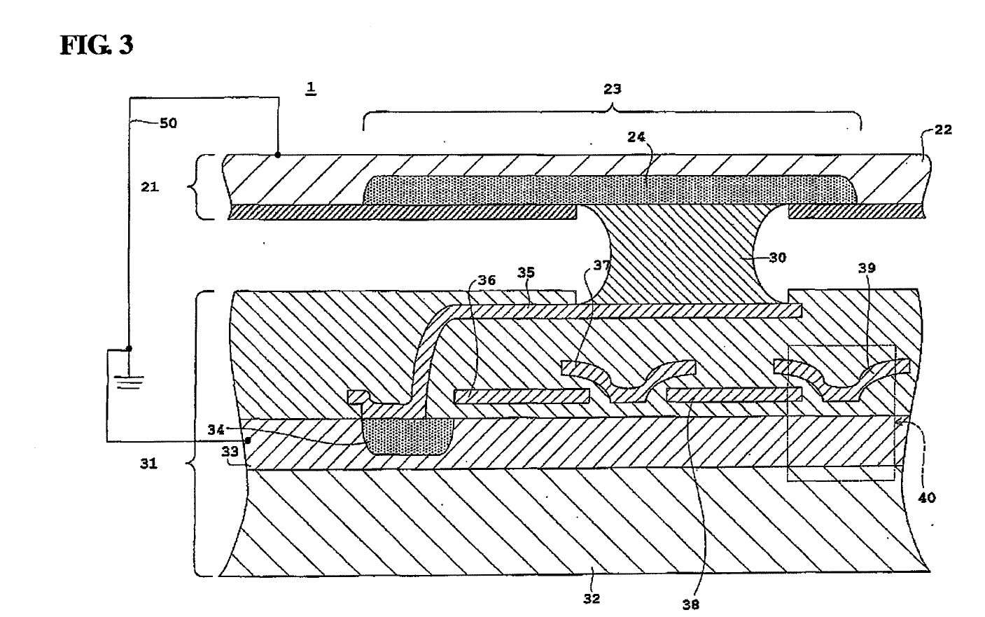

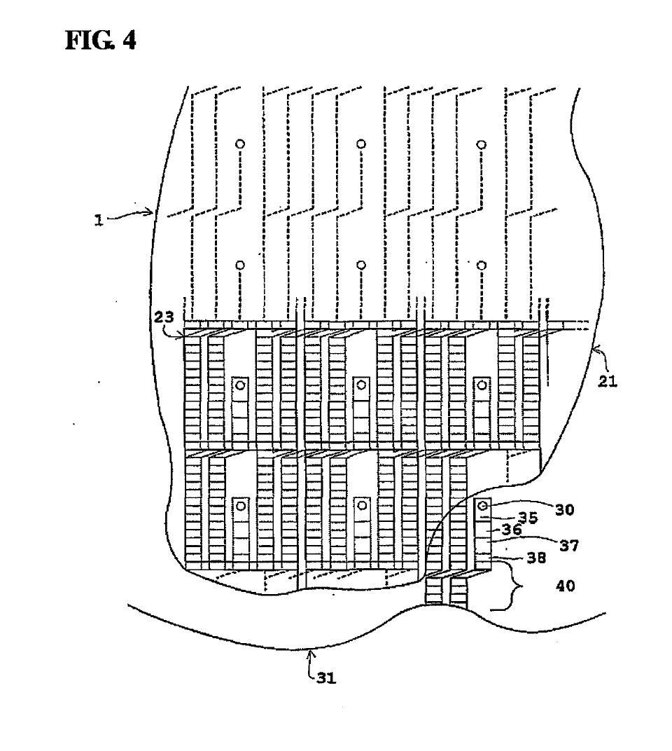

The power supply section 9a is operable to apply a voltage to a readout gate 14 (see FIG. 2) for reading out a signal charge, a transfer gate 39 (see FIG. 3) for transferring a signal charge in the CCD 1, etc, which are discussed below. The timing generator 9b is operable to generate a voltage-applying timing signal, an image-pickup timing signal, and a clock signal. Specifically, in this embodiment, the timing generator 9b is operable, after an elapse of a exposure time discussed below, to control a timing of applying a voltage to the readout gate 14, and the power supply section 9a is operable, based on the voltage-applying timing signal from the timing generator 9b, to apply a voltage to the readout gate 14. Further, in this embodiment, the timing generator 9b is operable to control a timing of applying a voltage to the transfer gate 39 for each shot (i.e., for each frame), and the power supply section 9a is operable, based on the voltage-applying timing signal from the timing generator 9b, to apply a voltage to the transfer gate 39. Respective operations of the power supply section 9a and the timing generator 9b will be more specifically described later with reference to FIGS. 3 and 4.

As shown in FIG. 2, the CCD 1 comprises a plurality of photodiodes 11 each operable to convert incident light (i.e., an optical image of an object) to electric charge and generate a signal charge corresponding to an intensity of the incident light, a plurality of charge-accumulating CCD cell arrays 12 each operable to accumulatively store respective signal charges generated from an associated one of the photodiodes 11, and a plurality of vertically shifting CCD cell arrays 13 each operable to shift respective signal charges accumulated in associated ones of the charge-accumulating CCD cell arrays 12, in a vertically downward direction (in FIG. 2). Each of the photodiodes 11 serves as the photoelectric conversion means set forth in the present invention. A combination of the charge-accumulating CCD cell array 12 and the vertically shifting CCD cell array 13 associated therewith serves as the plurality of charge accumulation means set forth in the present invention.

A readout gate 14 is provided on one side of each of the photodiodes 11 to read out a signal charge from the photodiode 11 and deliver the readout signal charge to an adjacent one of the charge-accumulating CCD cell arrays 12. The charge-accumulating CCD cell array 12 is formed by connecting a plurality of charge-accumulating CCD cells in a line shape, and provided in plural number. In the same manner, the vertically shifting CCD cell array 13 is formed by connecting a plurality of vertically shifting CCD cells in a line shape, and provided in plural number. Signal charges generated from each of the photodiodes 11 are sequentially accumulated in the respective charge-accumulating CCD cells in an adjacent one of the charge-accumulating CCD cell arrays 12, in a sequentially shifting manner. Then, the sequentially shifted signal charges from each of the charge-accumulating CCD cell arrays 12 are merged into an associated one of the vertically shifting CCD cell arrays 13. Through the vertically shifting CCD cell array 13, the signal charges are delivered to a horizontally transferring CCD cell 15. The horizontally transferring CCD cell 15 is operable to transfer each of the signal charges outside the CCD 1. The horizontally transferring CCD cell 15 serves as the transfer means set forth in the present invention.

The photodiodes 11 are two-dimensionally arranged, i.e., aligned parallel to horizontal and vertical directions. Due to this arrangement, each of the charge-accumulating CCD cell arrays 12 is arranged to extend in a diagonal direction. Therefore, the CCD 1 in this embodiment is called “diagonal CCD-type solid-state image pickup device”.

As above, the diagonal arrangement of the charge-accumulating CCD cell arrays 12 allows the photodiodes 11 to be arranged in such a manner as to be aligned parallel to horizontal and vertical directions. If each of the charge-accumulating CCD cell arrays 12 is arranged to extend vertically, each of the photodiodes 11 will be arranged in a diagonal direction. In the “diagonal CCD-type solid-state image pickup device”, the photodiodes 11 are disposed in a perpendicular arrangement, instead of the diagonal arrangement.

The following description will be made on the assumption that a photodiode 23, readout gate 38 and CCD cell array 40, which are shown in FIGS. 3 and 4 and discussed below, are identical, respectively, to the photodiode 11, the readout gate 14, and a combination of the charge-accumulating CCD cell array 12, the vertically transferring CCD cell array 13 and the horizontally transferring CCD cell 15, in FIG. 2. That is, in the CCD cell array 40 illustrated in FIGS. 3 and 4, a portion for accumulatively storing signal charges serves as the charge accumulation means set forth in the present invention, and a portion for reading out the accumulated signal charges and transferring the readout signal charges to outside serves as the charge transfer means set forth in the present invention. FIG. 3 is a sectional view showing the structure of the CCD, and FIG. 4 is a top plan view showing the configuration of the CCD.

As one feature of the exemplary embodiment, a board formed with a photodiode 23 in FIGS. 3 and 4 (or the photodiode 11 in FIG. 2) serving as the photoelectric conversion means set forth in the present invention (this board will hereinafter be referred to as “light-receptor board”), and a board formed with a CCD cell array 40 in FIGS. 3 and 4 (or the combination of the charge-accumulating CCD cell array 12, the vertically transferring CCD cell array 13 and the horizontally transferring CCD cell 15, in FIG. 2) serving as the charge accumulation means and the charge transfer means set forth in the present invention (this board will hereinafter be referred to as “CCD-cell board”), are arranged separately from each other and electrically connected to each other.

In this embodiment, as shown in FIGS. 3 and 4, the light-receptor board 21 is disposed above the CCD-cell board 31, and a metal bump 30 is used for electrically connecting the two boards 21, 31 to each other. Specifically, the light-receptor board 21 is supported by the CCD-cell board 31 through the metal bump 30 associated in one-to-one corresponding relation with the photodiode 23, with a distance of about several hundred μm between the two boards 21, 31. The means for electrically connecting the two boards 21, 31 to each other is not limited to a bump, such as the metal bump 30, but may be for example a metal line (i.e., metal wire). When the metal bump 30 is used as the electrical connection means, it may be made of indium.

As shown in FIG. 3, the light-receptor board 21 comprises a p-type substrate 22 and the photodiode 23. The photodiode 23 has an n-region 24. Specifically, in the light-receptor board 21, the p-type substrate 22 consists of a p-type silicon substrate, and an n-type impurity is injected into the p-type substrate 22 to form an n-p type photodiode 23. The plurality of photodiodes 23 are two-dimensionally arranged, as shown in FIG. 4. The metal bump 30 is brought into contact with the n-region 24, and electrically connected thereto.

In this embodiment, a “back-illuminated type” photodiode adapted to allow light to be entered into the n-region 24 through the p-type substrate 22 is used as the photodiode 23. As contrast to the “back-illuminated type” photodiode adapted to allow light to be entered into the n-region 24 through the p-type substrate 22, a photodiode adapted to allow light to be directly entered into the n-region 24 is called “front-illuminated type”. In the arrangement where the light-receptor board 21 is disposed above the CCD-cell board 31, it is preferable to emit light downwardly from above the light-receptor board 21, and a back-illuminated type photodiode is used as the photodiode 23.

If light is emitted upwardly from below the CCD-cell board 31, the light is obliged to pass through the CCD-cell board 31, and is thereby likely to be unable to reach the n-region 24. Thus, it is necessary to emit light downwardly from above the light-receptor board 21.

In cases where light is emitted downwardly from above the light-receptor board 21, and the front-illuminated type photodiode is used as the photodiode 23, the n-region 24 is formed in an upper surface of the p-type substrate 22. Thus, the n-region 24 is not disposed in directly opposed relation to a polysilicon line 35 discussed below, and thereby the n-region 24 and the polysilicon line 35 have to be electrically connected to each other through a metal line or the like, instead of the metal bump 30. This causes complication in design for the CCD due to need for wiring of the metal line or the like. Thus, the opposed arrangement between the n-region 24 and the polysilicon line 35 is essential to allowing the n-region 24 and the polysilicon line 35 to be electrically connected to each other through the metal bump 30. From this point of view, the back-illuminated type photodiode where the n-region 24 is formed in a bottom surface of the p-type substrate 22 is preferably used as the photodiode 23. If there is no need to consider CCD design efficiency, the front-illuminated type photodiode may be used.

In cases where light is emitted downwardly from above the light-receptor board 21, and the back-illuminated type photodiode is used as the photodiode 23, although the light will pass through the p-type substrate 22, a level of light attenuation can be lowered as compared with the case of transmitting the light through the CCD-cell board 31. In addition, the p-type substrate 22 may be formed to have a smaller thickness so as to more reliably suppress the light attenuation.

The CCD-cell board 31 comprises an n-type substrate 32, a p-well region 33, an n+ region 34, a polysilicon line 35, a DC gate 36, a collection gate 37, a readout gate 38, and a transfer gate 39. The CCD cell array 40 is made up of the transfer gate 39 and a portion of the p-well region located immediately below the transfer gate 39. Preferably, the p-type substrate 22 of the light-receptor board 21 and the p-well region 33 of the CCD-cell board 31 are electrically connected to each other through a grounding line 50 to allow the p-type substrate 22 and the p-well region 33 to be grounded at the same potential.

Specifically, in the CCD-cell board 31, the n-type substrate 32 consists of an n-type silicon substrate, and a p-type impurity is injected into the n-type substrate 32 to form the p-well region 33. An n-type impurity is injected into the p-well region 33 to form the n+ region 34 to which the n-region 24 of the light-receptor board 21 is connected through the metal bump 30. The n-type impurity is injected into the n+ region 34 at a higher concentration than that in the n-region 24 of the photodiode 23. The polysilicon line 35 is formed immediately above the n+ region 34, and the metal bump 30 is brought into contact with the polysilicon line 35 and electrically connected thereto. In this manner, the n-region 24 of the light-receptor board 21 is electrically connected to the n+ region 34 of the CCD-cell board 31, and the two boards 21, 31 are electrically connected to each other.

The DC gate 36, the collection gate 37, the readout gate 38 and the transfer gate 39 are arranged in this order from a vicinity of the n+ region 34 toward a direction for transferring signal charges to outside. A constant voltage is applied to the DC gate 36. The collection gate 37 is applied with a voltage capable of forming a potential (potential well) deeper than that to be formed by the DC gate 36.

The collection gate 37 is operable to collect signal charges generated from the photodiode 23 (or the photodiode 11 in FIG. 2) and transfer the collected signal charges to the charge-accumulating CCD cell array 12 (see FIG. 2) through the readout gate 38 (or the readout gate 14 in FIG. 2). The reason will be described later. The collection gate 37 serves as the collection means set forth in the present invention.

While the CCD-cell board 31 is formed with an amplifier (not shown), a reset section (not shown), a drain section (not shown), etc., in addition to the above elements, their description will be omitted.

An operation of the CCD 1 will be described below. In response to entrance of light into the photodiode 23 (or the photodiode 11 in FIG. 2), a signal charge is generated based on a photoelectric effect. The n+ region 34 of the CCD-cell board 31 connected to the n-region 24 of the photodiode 23 through the metal bump 30 has a deeper potential than that in the n-region 24. Thus, the signal charge generated in the photodiode 23 is moved to the n+ region 34 through the metal bump 30 and the polysilicon line 35.

When the potential in the n+ region 34 is increased by the collected signal charge, up to a value greater than that formed by the constant voltage applied to the DC gate 36, the signal charge is overspilled from the n+ region 34 and collected into the potential well formed immediately below the collection gate 37. After an elapse of an exposure time for one shot (i.e., one frame), a voltage is applied to the readout gate 38 (or the readout gate 14 in FIG. 2) to turn on a channel located immediately below the readout gate 38 so as to forward the signal charge collected immediately below the collection gate 37, to the charge-accumulating CCD cell array 12 (see FIG. 2). A timing of forwarding the signal charge is determined by the power supply section 9a and the timing generator 9b.

In this manner, the collection gate 37 collects a signal charge generated from the photodiode 23 (or the photodiode 11 in FIG. 2), and forwards the collected signal charge to the charge-accumulating CCD cell array 12 through the readout gate 38 (or the readout gate 14 in FIG. 2).

Signal charges are sequentially accumulated in the charge-accumulating CCD cell array 12 in a sequentially shifting manner, by switching the transfer gate 39 for each shot (i.e., for each frame) while applying a voltage thereto. After completion of shooting, the accumulated signal charges are sequentially shifted from the charge-accumulating CCD cell array 12 to the vertically transferring CCD cell array 13. Then, the signal charges are sequentially delivered from the vertically transferring CCD cell array 13 to the horizontally transferring CCD cell array 15, and output outside the CCD 1 through an amplifier. Respective timings of shifting and transferring each of the signal charges are also determined by the power supply section 9a and the timing generator 9b. The signal charges output outside the CCD 1 are formed as two-dimensional images through various processings in the correlated double sampling section 3, the A/D converter 4, the image processing section 5, etc., as shown in FIG. 1.

In the CCD 1 and the imaging apparatus using the CCD 1, the light-receptor board 21 formed with the photodiode 23 (or the photodiode 11 in FIG. 2), and the CCD-cell board 31 formed with the CCD cell array 40 (or the combination of the charge-accumulating CCD cell array 12, the vertically transferring CCD cell array 13 and the horizontally transferring CCD cell 15, in FIG. 2) serving as the charge accumulation means and the charge transfer means, are arranged separately from each other and electrically connected to each other. In the above embodiment, the two boards 21, 31 are electrically connected to each other through the metal bump 30. The separate arrangement between the light-receptor board 21 formed with the photodiode 23 and the CCD-cell board 31 formed with the CCD cell array 40 allows restrictions on design for the photodiode 23 (or the photodiode 11 in FIG. 2) and the CCD cell array 40.

Thus, for example, an approximately entire surface of the light-receptor board 21 can be utilized as the photodiode 23 to allow an aperture ratio to be increased so as to provide enhanced sensitivity to light. In addition, an area of the CCD-cell board 31 for layout of the CCD cell array 40 can be increased to provide enhanced flexibility in design for the photodiode 23 and the CCD cell array 40. For example, the number of CCD cells in the array 40 may be increased to increase the number of storable shots (i.e., frames). Furthermore, the separate arrangement between the two boards allows the photodiode 23 and the CCD cell array 40 formed in the respective boards 21, 31 to be disposed in spaced-apart relation to each other. This makes it possible to prevent leak of light and/or a signal charge from the photodiode 23 into the CCD cell array 40 so as to avoid deterioration in image quality.

As seen in FIGS. 2 and 4, in the above embodiment, the photodiode 11 (or the photodiode 23 in FIG. 4) is associated in one-to-one corresponding relation with an adjacent one of the charge-accumulating CCD cells in the charge-accumulating CCD cell array 12 (or an upstreammost one of a plurality of CCD cells in the CCD cell array 40). Further, the plurality of charge-accumulating CCD cells in each of the charge-accumulating CCD cell arrays 12 are connected in series while setting the adjacent or upstreammost charge-accumulating CCD cell associated in one-to-one corresponding relation with the photodiode 14 (or 23), as an initial one of the charge-accumulating CCD cells, and a plurality of vertically shifting CCD cells in an associated one of the vertically shifting CCD cell arrays 13 are connected in series to the charge-accumulating CCD cell arrays 12. Then, a last one of the series-connected charge-accumulating CCD cells and vertically shifting CCD cells in the respective charge-accumulating CCD cell array 12 and vertically shifting CCD cell array 13 is connected to the horizontally transferring CCD cell 15. This arrangement makes it possible to accumulatively store desired signal charges depending on the number of the series-connected charge-accumulating CCD cells and vertically shifting CCD cells in the respective charge-accumulating CCD cell array 12 and vertically shifting CCD cell array 13.

In the above embodiment, the plurality of charge-accumulating CCD cells in each of the charge-accumulating CCD cell arrays 12 and a plurality of vertically shifting CCD cells in an associated one of the vertically shifting CCD cell arrays 13 are connected in series, and signal charges are sequentially accumulated in the series-connected CCD cells in a sequentially shifting manner. Then, the horizontally transferring CCD cell 15 transfers each of the sequentially accumulated and shifted signal charges, outside the CCD 1 at a predetermined timing (in the above embodiment, at a time of completion of shooting). This shifting and transfer process makes it possible to accumulatively store desired signal charges depending on the number of the series-connected charge-accumulating CCD cells and vertically shifting CCD cells in the respective charge-accumulating CCD cell array 12 and vertically shifting CCD cell array 13, while reliably shifting and transferring the signal charges.

The image pickup device in the above embodiment is provided with the collection gate 37 operable to collect a signal charge generated from the photodiode 23 (or the photodiode 11 in FIG. 2) and deliver the collected signal charge to the charge-accumulating CCD cell array 12 (see FIG. 2) through the readout gate 38 (or the readout gate 14 in FIG. 2). The collection gate 37 is also formed as a part of the CCD-cell board 31. This arrangement makes it possible to prevent leak of light and/or a signal charge from the photodiode 23 into the collection gate 37. The prevention of the leak into the collection gate 37 also allows the leak into the readout gate 38 and the transfer gate 39 to be blocked so as to avoid deterioration in image quality.

An advantageous embodiment of the invention has been shown and described. It is obvious to those skilled in the art that various changes and modifications may be made therein without departing from the spirit and scope thereof as set forth in appended claims. For example, the above embodiment may be modified and changed as follows.

(1) While the above embodiment has been described based on one example where the image pickup device is designed for high-speed imaging requiring a shooting speed of 100,000 frames/sec or more, the present invention may be applied to an image pickup device for normal imaging to be performed at a shooting speed of less than 100,000 frames/sec.

(2) While the above embodiment has been described based on one example where a photodiode is used as the photoelectric conversion means, the photoelectric conversion means in the present invention is not limited to a photodiode. For example, a photogate may be used as the photoelectric conversion means.

(3) The above embodiment has been described by taking the “diagonal CCD-type solid-state image pickup device” as an example. The present invention may also be applied to an image pickup device designed such that each of the charge-accumulating CCD arrays is arranged to extend vertically.

(4) The light-receptor board 21 in the above embodiment is disposed above the CCD-cell board 31. Alternatively, the CCD-cell board 31 may be disposed above the light-receptor board 21.

(5) The two boards in the above embodiment are arranged in vertically opposed relation to each other. Alternatively, the two boards may be arranged in horizontal opposed relation to each other.

(6) The present invention may be applied to any suitable image pickup system. A major image pickup system includes an IL (Interline) type, a FT (Frame Transfer) type, a FFT (Full Frame Transfer) type and a FIT (Frame Interline Transfer) type. The configuration and/or structure of the image pickup device may be adequately modified depending on these systems.

What is claimed is:

1. An image pickup device comprising:
photoelectric conversion means operable to convert incident light to electric charge and generate a signal charge corresponding to an intensity of the incident light;
a plurality of charge accumulation means operable to accumulatively store respective signal charges generated from said photoelectric conversion means; and
charge transfer means operable to read out each of the signal charges accumulated in said plurality of charge accumulation means and transfer said read-out signal charge to outside,
wherein said photoelectric conversion means is formed as a part of a first board, and said plurality of charge accumulation means and said charge transfer means are formed as a part of a second board, said first and second boards being arranged separately from each other and electrically connected to each other.

2. The image pickup device as defined in claim 1, wherein:
said photoelectric conversion means and a predetermined one of said plurality of charge accumulation means are associated in one-to-one corresponding relation with each other; and
said plurality of charge accumulation means are connected in series in such a manner that said predetermined charge accumulation means associated in one-to-one corresponding relation with said photoelectric conversion means is set as an initial one of said series-connected charge accumulation means, and a last one of said series-connected charge accumulation means is connected to said charge transfer means.

3. The image pickup device as defined in claim 1, wherein:
said plurality of charge accumulation means are connected in series, and operable to sequentially accumulate respective signal charges in said series-connected charge accumulation means in a sequentially shifting manner; and
said charge transfer means is operable to transfer each of said sequentially accumulated and shifted signal charges to outside at a predetermined timing.

4. The image pickup device as defined in claim 1, which includes collection means operable to collect respective signal charges generated from said photoelectric conversion means and deliver said collected signal charges to said charge transfer means, said collection means being formed as a part of said second board having said plurality of charge accumulation means.

5. An imaging apparatus comprising the image pickup device as defined in claim 1, said image pickup device including:
photoelectric conversion means operable to convert incident light to electric charge and generate a signal charge corresponding to an intensity of the incident light;
a plurality of charge accumulation means operable to accumulatively store respective signal charges generated from said photoelectric conversion means; and
charge transfer means operable to read out each of the signal charges accumulated in said plurality of charge accumulation means and transfer said read-out signal charge to outside,
wherein said photoelectric conversion means is formed as a part of a first board, and said plurality of charge accumulation means and said charge transfer means are formed as a part of a second board, said first and second boards being arranged separately from each other and electrically connected to each other.

6. The image pickup device as defined in claim 2, wherein:
said plurality of charge accumulation means are connected in series, and operable to sequentially accumulate respective signal charges in said series-connected charge accumulation means in a sequentially shifting manner; and
said charge transfer means is operable to transfer each of said sequentially accumulated and shifted signal charges to outside at a predetermined timing.

7. The image pickup device as defined in claim 2, which includes collection means operable to collect respective signal charges generated from said photoelectric conversion means and deliver said collected signal charges to said charge transfer means, said collection means being formed as a part of said second board having said plurality of charge accumulation means.

8. The image pickup device as defined in claim 3, which includes collection means operable to collect respective signal charges generated from said photoelectric conversion means and deliver said collected signal charges to said charge transfer means, said collection means being formed as a part of said second board having said plurality of charge accumulation means.

9. The image pickup device as defined in claim 6, which includes collection means operable to collect respective signal charges generated from said photoelectric conversion means and deliver said collected signal charges to said charge transfer means, said collection means being formed as a part of said second board having said plurality of charge accumulation means.

10. An imaging apparatus comprising the image pickup device as defined in claim 2, said image pickup device including:
photoelectric conversion means operable to convert incident light to electric charge and generate a signal charge corresponding to an intensity of the incident light;
a plurality of charge accumulation means operable to accumulatively store respective signal charges generated from said photoelectric conversion means; and
charge transfer means operable to read out each of the signal charges accumulated in said plurality of charge accumulation means and transfer said read-out signal charge to outside,
wherein said photoelectric conversion means is formed as a part of a first board, and said plurality of charge accumulation means and said charge transfer means are formed as a part of a second board, said first and second boards being arranged separately from each other and electrically connected to each other.

11. An imaging apparatus comprising the image pickup device as defined in claim 3, said image pickup device including:
photoelectric conversion means operable to convert incident light to electric charge and generate a signal charge corresponding to an intensity of the incident light;
a plurality of charge accumulation means operable to accumulatively store respective signal charges generated from said photoelectric conversion means; and
charge transfer means operable to read out each of the signal charges accumulated in said plurality of charge accumulation means and transfer said read-out signal charge to outside,
wherein said photoelectric conversion means is formed as a part of a first board, and said plurality of charge accumulation means and said charge transfer means are formed as a part of a second board, said first and second boards being arranged separately from each other and electrically connected to each other.

12. An imaging apparatus comprising the image pickup device as defined in claim 6, said image pickup device including:
photoelectric conversion means operable to convert incident light to electric charge and generate a signal charge corresponding to an intensity of the incident light;
a plurality of charge accumulation means operable to accumulatively store respective signal charges generated from said photoelectric conversion means; and
charge transfer means operable to read out each of the signal charges accumulated in said plurality of charge accumulation means and transfer said read-out signal charge to outside,
wherein said photoelectric conversion means is formed as a part of a first board, and said plurality of charge accumulation means and said charge transfer means are formed as a part of a second board, said first and second boards being arranged separately from each other and electrically connected to each other.

13. An imaging apparatus comprising the image pickup device as defined in claim 7, said image pickup device including:
photoelectric conversion means operable to convert incident light to electric charge and generate a signal charge corresponding to an intensity of the incident light;
a plurality of charge accumulation means operable to accumulatively store respective signal charges generated from said photoelectric conversion means; and
charge transfer means operable to read out each of the signal charges accumulated in said plurality of charge accumulation means and transfer said read-out signal charge to outside,
wherein said photoelectric conversion means is formed as a part of a first board, and said plurality of charge accumulation means and said charge transfer means are formed as a part of a second board, said first and second boards being arranged separately from each other and electrically connected to each other.

14. An imaging apparatus comprising the image pickup device as defined in claim 8, said image pickup device including:
photoelectric conversion means operable to convert incident light to electric charge and generate a signal charge corresponding to an intensity of the incident light;
a plurality of charge accumulation means operable to accumulatively store respective signal charges generated from said photoelectric conversion means; and
charge transfer means operable to read out each of the signal charges accumulated in said plurality of charge accumulation means and transfer said read-out signal charge to outside,
wherein said photoelectric conversion means is formed as a part of a first board, and said plurality of charge accumulation means and said charge transfer means are formed as a part of a second board, said first and second boards being arranged separately from each other and electrically connected to each other.

15. An imaging apparatus comprising the image pickup device as defined in claim 9, said image pickup device including:
photoelectric conversion means operable to convert incident light to electric charge and generate a signal charge corresponding to an intensity of the incident light;
a plurality of charge accumulation means operable to accumulatively store respective signal charges generated from said photoelectric conversion means; and
charge transfer means operable to read out each of the signal charges accumulated in said plurality of charge accumulation means and transfer said read-out signal charge to outside,
wherein said photoelectric conversion means is formed as a part of a first board, and said plurality of charge accumulation means and said charge transfer means are formed as a part of a second board, said first and second boards being arranged separately from each other and electrically connected to each other.
